(19) United States
(12) Patent Application Publication
(10) Pub. No.: US 2005/0219649 A1
(43) Pub. Date: Oct. 6, 2005

(54) Apparatus and method to scan three-dimensional object

(76) Inventor: Hyun Kim, Suwon-si (KR)

Correspondence Address: STANZIONE & KIM, LLP, 1740 N STREET, N.W., FIRST FLOOR, WASHINGTON, DC, 20036, US

(21) Appl. No.: 10/975,068

(22) Filed: Oct. 28, 2004

(30) Foreign Application Priority Data
Nov. 3, 2003 (KR) 2003-77336

(51) Int. Cl. H04N 1/04

(52) U.S. Cl. 358/486; 358/474

(57) ABSTRACT

An apparatus to scan a three-dimensional object includes a sensor unit which scans an object or image on a glass plane by first and second scan control signals; a signal processing unit which performs signal processing on an image scanned by the sensor unit; and a control unit which outputs a first scan control signal if the object or image scanned is a three-dimensional object, partitions a first scan image scanned by the sensor unit into a predetermined size of regions, compares average brightness differences between the regions with a reference value to classify the regions into object and non-object regions, and outputs a second scan control signal to perform a second scan on the object regions and processes the non-object regions as white level regions. In scanning the three-dimensional object, it is possible to minimize unnecessary image data in the non-object regions (i.e., background) and to scan only the object not including the background. Therefore, it is possible to reduce printing time and ink when the object or image is copied.

### CROSS-REFERENCE TO RELATED APPLICATIONS

This application claims the priority of Korean Patent Application No. 2003-77336, filed on Nov. 3, 2003, in the Korean Intellectual Property Office, the disclosure of which is incorporated herein in its entirety and by reference.

### BACKGROUND OF THE INVENTION

1. Field of the Invention

The present general inventive concept relates to an apparatus and a method to scan an image, and more particularly, to an apparatus for and a method of scanning a three-dimensional original copy.

2. Description of the Related Art

A scanning device includes a scanner for scanning an original image by using a scan sensor such as a charge coupled device (CCD) sensor and converting a scanned image into computer-readable data, and a copy machine for duplicating the original image and transferring a duplicated image on a paper.

FIG. 1 shows a typical scanning device. The scanning device comprises a glass plane 100, a scan sensor 101, an original cover 102, and a main body 103. The glass plane 100 is a place where an original copy 104 is positioned. The scan sensor 101 moves under the glass plane 100 to read out an original image from the original copy 104 positioned on the glass plane 100. An image sensor such as the CCD sensor is used as a scan sensor 101. The original cover 102 is hinged at one side of the glass plane 100 and flipped up and down so as to open and close the glass plane 100. The original cover 102 presses down the original copy 104 into close contact with the glass plane 100. This allows the scan sensor 101 to clearly scan the original copy 104. The main body 103 supports the glass plane 100 and the original cover 102, and provides space for operating the scan sensor 101 therein.

Now, scanning operations of a scanning device will be described. First, a user opens the original cover and adjusts the position of the original copy 104 on the glass plane 100, and closes the original cover 102. Next, the user presses buttons (not shown) in order to input commands. When a start command is input, the scan sensor 101 starts to scan the original copy 104 on the glass plane 100, and converts a scanned image into computer-readable image data or transfers the scanned image on a paper.

Typically, if the start command is input to the scanning device, the scan operation always starts irrespective of whether or not the original cover 102 is closed.

When scanned or printed with the scanning device, a solid object, i.e., a three-dimensional object is placed on a partial region of the glass plane 100. Since the solid object has a certain height, the original cover 102 may not fully cover the solid object. In other words, if the height of the solid object is larger than a certain level, the original cover 102 may not be fully closed, and unnecessary light can be incident to the scan sensor 101. Therefore, background, that is, a region not including the area of the solid object, may not result in a white color, but in a color of a predetermined brightness. FIG. 2 shows a case where the background is not in white but in the predetermined brightness.

As shown in FIG. 2, when the background is in a gray level, an additional time is required to print the background. In addition, an amount of ink is unnecessarily consumed. Furthermore, the background has a particular “color.”

### SUMMARY OF THE INVENTION

The present general inventive concept provides an apparatus and a method to scan a three-dimensional object, capable of minimizing image data of a non-object region, i.e., background, and scanning only an object region not including the background.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing an apparatus to scan a three-dimensional object, the apparatus including a sensor unit, a signal processing unit, and a control unit. The sensor unit scans an object (or document) on a glass plane by first and second scan control signals. The signal processing unit performs signal processing on an image scanned by the sensor unit. The control unit outputs a first scan control signal if the object is a three-dimensional object, partitions a first scan image scanned by the sensor unit into regions, compares average brightness differences between the regions with a reference value to classify the regions into object and non-object regions, and outputs a second scan control signal to perform a second scan on the object regions and processes the non-object regions as white level regions.

The apparatus may further include a storage unit to store the first scan image.

The control unit may include a region partitioning unit, a comparison unit, and a scan region determination unit. The region partitioning unit can partition the first scan image stored in the storage unit into regions and can calculate an average brightness of the partitioned region. The comparison unit can compare average brightness differences between the partitioned regions with the reference value. The scan region determination unit can determine the partitioned regions to be object or non-object regions based on a result of the comparison and can output a second scan control signal.

The region partitioning unit may partition the first scan image into horizontal/vertical regions in units of a predetermined pixel or size. The scan region determination unit may determine regions having average brightness differences smaller than the reference value to be the non-object regions and output a control signal to perform a white level process on the non-object regions. The scan region determination unit may determine regions having average brightness differences larger than the reference value to be the object regions and output a control signal to process the object regions as image data regions.

The forgoing and/or other aspects and advantages of the present general inventive concept may also be achieved by providing a method of scanning a three-dimensional object, the method including: if an object (or document) on a glass plane is a three-dimensional object, covering the three-dimensional object with an original cover and performing a first scan on the three-dimensional object and storing a scanned image as a first scan image; partitioning the first scan image into regions and comparing average brightness differences between the regions with a reference value; and classifying the regions into object and non-object regions based on a result of the comparison and directing a second scan to scan the object regions and performing a white level process on the non-object regions.

In the partitioning of the first scan image operation, the first scan image may be partitioned into horizontal/vertical regions in units of a predetermined pixel or size. The partitioning of the first scan image operation may include partitioning the first scan image into regions and calculating average brightness of the regions, comparing average brightness of the regions and average brightness of adjacent regions, and comparing the average brightness difference with the reference value.

In the classifying of the object regions operation, regions having average gray level differences smaller than the reference value as a result of the comparison may be determined to be the non-object regions and processing the non-object regions as white level regions during the second scan. In the classifying of the object regions operation, regions having average brightness differences larger than the reference value as a result of the comparison may be determined to be the object regions and processed as image data regions during the second scan.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view showing a conventional scanning apparatus having an original cover;

FIG. 2 is a picture obtained by performing an exemplary image scanning on a three-dimensional object with the scanning apparatus of FIG. 1;

FIG. 3 is a block diagram showing a construction of a scanning apparatus to scan a three-dimensional object (or document), according to an embodiment of the present general inventive concept;

FIG. 4A is a picture of an entire scan area when an original cover is not fully closed;

FIG. 4B is a schematic diagram showing average brightness in portions of the entire scan area of FIG. 4A; and

FIG. 5 is a flowchart showing operations of a method of scanning a three-dimensional object, according to an embodiment of the present general inventive concept.

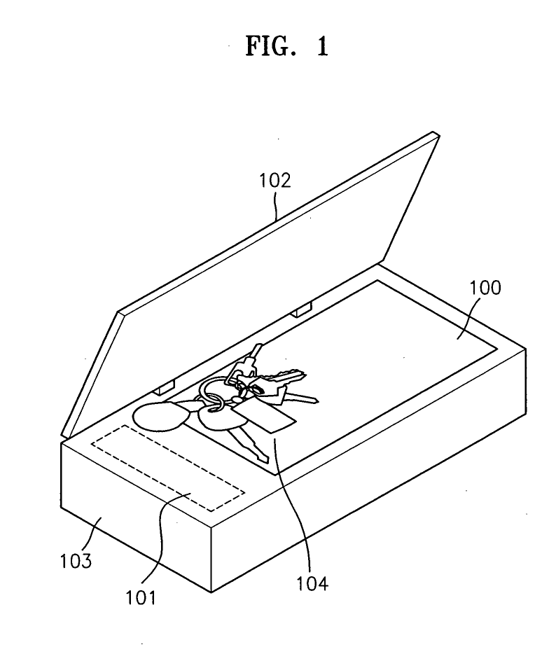

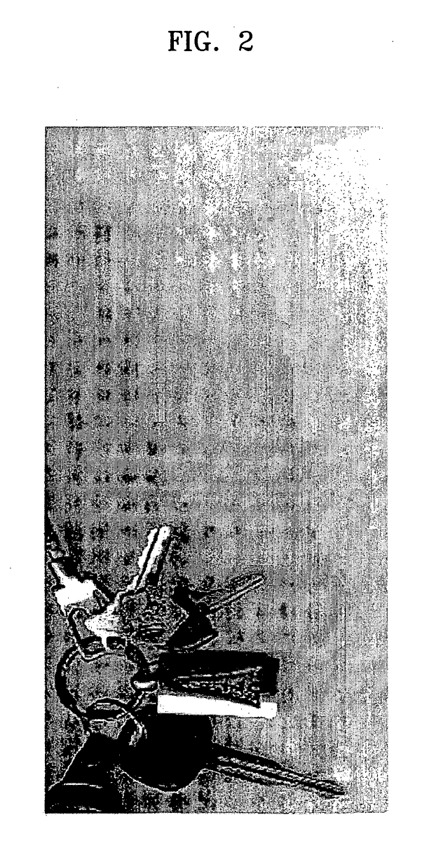

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

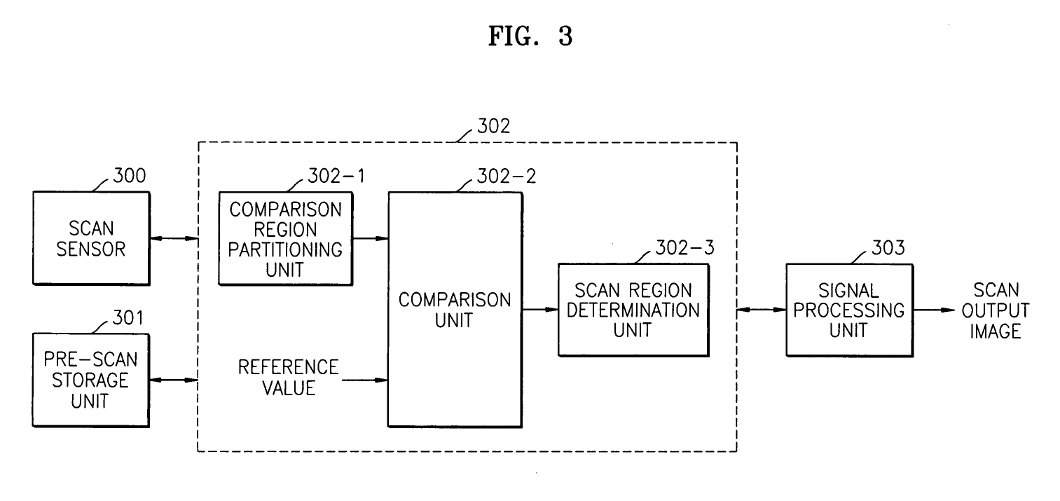

FIG. 3 is a block diagram showing a structure of an apparatus to scan a three-dimensional object (or document) according to an embodiment of the present general inventive concept. The apparatus may include a scan sensor 300, a pre-scan storage unit 301, a control unit 302, and a signal processing unit 303. According to the embodiment of FIG. 3, the control unit 302 may include a comparison region partitioning unit 302-1, a comparison unit 302-2, and a scan region determination unit 302-3.

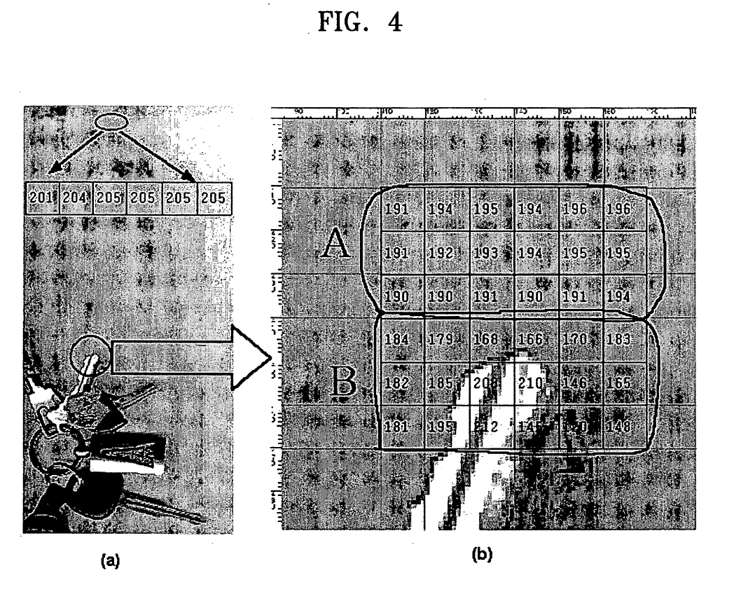

FIG. 4A shows an entire scan area when the original cover is not fully closed. FIG. 4B shows average brightness in portions of the entire scan area.

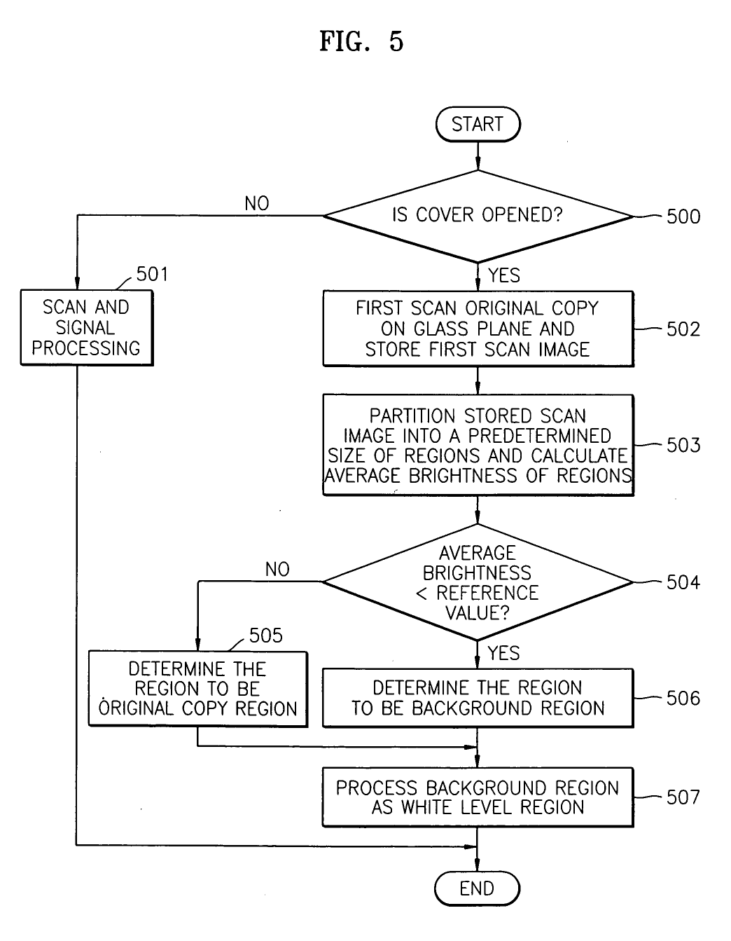

FIG. 5 is a flow chart showing operations of a method of scanning a three-dimensional object, according to another embodiment of the present general inventive concept. The method includes an operation 500 of determining whether or not the original cover is fully closed; an operation 501 of scanning an object (or image) and processing image signals if the original cover is fully closed; an operation 502 of performing a first scan on the object on a glass plane and storing the first scan image if the original cover is not fully closed; an operation 503 of partitioning the stored first scan image into a predetermined size of regions and calculating average brightness for the partitioned regions; an operation 504 of determining whether or not average brightness differences between the regions are less than a reference value; an operation 505 of determining regions having average brightness differences greater than the reference value to be object regions; an operation 506 of determining regions having average brightness differences less than the reference value to be non-object regions and processing the non-object regions as white level regions during a second scan; and an operation 507 of performing a second scan based on the region determination and processing image signals.

Now, the embodiments of the present general inventive concept will be described in detail with reference to FIGS. 3 to 5.

First, an apparatus to scan a three-dimensional object (or document/image) will be described in detail with reference to FIGS. 3 and 4.

The scan sensor 300 may be an image sensor such as a charge coupled device (CCD) sensor to scan the object (or document/image) on the glass plane. The scan sensor 300 is operated by a scan control signal. If the object on the glass plane is two-dimensional, one scanning operation is performed according to the scan control signal. However, if the object on the glass plane is three-dimensional, two scanning operations, that is, first and second scanning operations, are performed according to first and second scan control signals, respectively.

The pre-scan storage unit 301 stores a first scan image from the scan sensor 300 if the object is three-dimensional.

The control unit 302 outputs the scan control signals depending on whether or not the original cover is fully closed, classifies the first scan image stored in the pre-scan storage unit 301 into object and non-object regions, and outputs a second scan control signal used to scan the object regions and perform a white level process on the non-image regions.

The control unit 302 may include a comparison region partitioning unit 302-1, a comparison unit 302-2, and a scan region determination unit 302-3.

The comparison region partitioning unit 302-1 partitions the first scan image stored in the pre-scan storage unit 301 into a predetermined size of regions and calculates average brightness for the regions. The comparison region partitioning unit 302-1 partitions the first scan image into horizontal/vertical regions in units of a predetermined pixel or size. For example, referring to FIG. 4B, a 10×10 pixel is set as a unit to partition the regions. Average gray levels of the pixel regions are 191, 194, 195, . . . , and so forth.

The comparison unit 302-2 compares average brightness of the regions partitioned by the comparison region partitioning unit 302-1 with those of neighboring regions to calculate average brightness differences. Next, the comparison unit 302-2 compares the average brightness differences with a reference value to output a comparison result.

The scan region determination unit 302-3 outputs a second scan control signal based on the comparison result of the comparison unit 302-2. The scan region determination unit 302-3 determines regions having average brightness differences smaller than the reference value to be non-object regions and outputs a scan control signal to process the non-object regions as white level regions (white being at a level of 255 in FIGS. 4A and 4B) during the second scan. Otherwise, the scan region determination unit 302-3 determines regions having the average brightness differences larger than the reference value to be object regions and outputs a scan control signal to process the object regions as image data regions during the second scan.

FIG. 4A shows an entire scan area when the original cover is not fully closed. FIG. 4B shows average brightness of portions A and B of the entire scan area in FIG. 4A. Here, the average brightnesses are obtained in units of a 10×10 pixel on the basis of 72 dpi. As shown in the entire scan area of FIG. 4A and the portion A in FIG. 4B, the average brightnesses are in a range from 190 to 205 and the average brightness differences between neighboring regions are in a range from 1 to 4. The average brightness differences can be typically formed by light influence. Therefore, regions having average brightness differences smaller than a reference value, for example, 4, can be determined to be white background.

In FIG. 4B, average brightness differences between the neighboring regions are at most 4 in the portion A and at least 4 in the portion B. Therefore, regions having average brightness differences of 4 or more between the neighboring regions are determined to be image data regions. The second scan is performed on the image data regions.

The signal processing unit 303 can convert the image data processed by the control unit 302 into computer-readable image data or can transfer the image data to a paper.

Now, a method of scanning a three-dimensional object according to an embodiment of the present general inventive concept will be described with reference to FIG. 5.

In operation 500, the control unit 302 determines whether or not the original cover is fully closed. If the original cover is not fully closed during a scan operation, the control unit 302 determines that the object (or document/image) on the glass plane is a three-dimensional object. In contrast, if the original cover is fully closed during the scan operation, the control unit 302 determines that the object (or document/image) is a two-dimensional document.

If the original cover is determined to be fully closed as a result of the determination made by the control unit 302, the scan sensor 300 scans the document/image, that is, the two-dimensional document/image, under the control of the control unit 302. The signal processing unit 303 converts the scanned image into computer-readable image data or transfers the scanned image to a paper.

In contrast, if the original cover is determined to be not fully closed as a result of the determination made by the control unit 302, a first scan is performed on the object, i.e., the three-dimensional object on the glass plane, under the control of the control unit 302 in operation 502. The result of the first scan is stored in the pre-scan storage unit 301.

When the first scan is completed, the comparison region partitioning unit 302-1 in the control unit 302 partitions the stored first scan image into a predetermined size of regions and calculates average gray levels of the partitioned regions in operation 503. The comparison region partitioning unit 302-1 may partition the first scan image stored in the pre-scan storage unit 301 into horizontal/vertical regions in units of a predetermined pixel or size.

Then, the comparison unit 302-2 in the control unit 302 compares average gray level differences between the partitioned regions with a reference level, and the scan region determination unit 302-3 determines whether the average gray level differences between the partitioned regions are smaller than the reference level.

The scan region determination unit 302-3 determines regions having the average gray level differences larger than the reference level to be object regions, and outputs a control signal to process the object regions as image data regions during the second scan.

Otherwise, the scan region determination unit 302-3 determines region having average gray level differences smaller than the reference level to be non-object regions, i.e., background, and outputs a control signal to process the non-object regions as white level regions during the second scan in operation 506.

Then, the scan sensor 300 performs a second scan on the object, that is, a three-dimensional object, under the control of the control unit 302, and the signal processing unit 303 performs signal processing to convert the scanned image into computer-readable image data or transfers the scanned image to a paper in operation 507.

According to present general inventive concept, in scanning a three-dimensional object, unnecessary image data in non-object regions (i.e., background) can be minimized and only the object area, that is, object regions not including the background can be scanned. Therefore, it is possible to reduce printing time and ink when image is transferred or printed.

The preferred embodiments of the present general inventive concept are disclosed in the drawings and the specification, as described above. In addition, although specific terms have been used hereto, the terms are intended to explain the present general inventive concept, but not intended to limit a meaning or restricting the scope of the present general inventive concept written in the following claims. Accordingly, it will be understood by those of ordinary skill in the art that various changes in form and details may be made therein without departing from the spirit and scope of the present general inventive concept as defined by the following claims.

1. An apparatus to scan a three-dimensional object, the apparatus comprising:
a sensor unit which scans an object or image on a glass plane by first and second scan control signals;
a signal processing unit which performs signal processing on an image scanned by the sensor unit; and
a control unit which outputs a first scan control signal if the object or image scanned is a three-dimensional object, partitions a first scan image scanned by the sensor unit into regions, compares average brightness differences between the regions with a reference value to classify the regions into object and non-object regions, and outputs a second scan control signal to perform a second scan on the object regions and to process the non-object regions as white level regions.

2. The apparatus according to claim 1, wherein the apparatus further comprises a storage unit to store the first scan image.

3. The apparatus according to claim 2, wherein the control unit comprises:
a region partitioning unit which partitions the first scan image stored in the storage unit into regions and calculates average brightnesses of the partitioned regions;
a comparison unit which compares average brightness differences between the partitioned regions with the reference value; and
a scan region determination unit which determines the partitioned regions to be object or non-object regions based on a result of the comparison and outputs the second scan control signal.

4. The apparatus according to claim 3, wherein the region partitioning unit partitions the first scan image into horizontal/vertical regions in units of a predetermined pixel or size.

5. The apparatus according to claim 3, wherein the scan region determination unit determines regions having average brightness differences less than the reference value to be the non-object regions and outputs a control signal to perform a white level process on the non-object regions.

6. The apparatus according to claim 3, wherein the scan region determination unit determines regions having average brightness differences greater than the reference value to be the object regions and outputs a control signal to process the object regions as image data regions.

7. A method of scanning a three-dimensional object, the method comprising:
if an object on a glass plane is a three-dimensional object, covering the three-dimensional object with an original cover and performing a first scan on the three-dimensional object and storing a scanned image as a first scan image;
partitioning the first scan image into regions and comparing average brightness differences between the regions with a reference value; and
classifying the regions into object and non-object regions based on a result of the comparison and directing a second scan to scan the object regions and perform a white level process on the non-object regions.

8. The method according to claim 7, wherein, in the partitioning of the first scan image operation, the first scan image is partitioned into horizontal/vertical regions in units of a predetermined pixel or size.

9. The method according to claim 7, wherein the partitioning of the first scan image comprises:
partitioning the first scan image into regions and calculating average brightness of the regions;
comparing average brightness of the regions and average brightness of adjacent regions; and
comparing the average brightness difference with the reference value.

10. The method according to claim 7, wherein, in the classifying of the regions operation, regions having average gray level differences less than the reference value as a result of the comparison are determined to be the non-object regions and are processed as white level regions during the second scan.

11. The method according to claim 7, wherein, in the classifying of the regions operation, regions having average brightness differences greater than the reference value as a result of the comparison are determined to be the object regions and are processed as image data regions during the second scan.

12. A scanning apparatus to scan an object between a glass plane and a cover, the apparatus comprising:
a sensor to scan the object;
a signal processor to perform signal processing on an image scanned by the sensor; and
a controller to generate a first scan control signal to operate the sensor to scan the object if the object is a three-dimensional object, to partition a first scan image scanned by the sensor into regions, to compare average brightness differences between the regions with a reference value to classify the regions into object and non-object regions, and to output a second scan control signal to operate the sensor to perform a second scan on the object regions while processing the non-object regions as white level regions.

13. The apparatus according to claim 12, further comprising a memory to store the first scan image.

14. The apparatus according to claim 13, wherein the controller comprises:
a region partitioner which partitions the first scan image stored in the memory into regions and calculates average brightnesses of the partitioned regions;
a comparator which compares average brightness differences between the partitioned regions with the reference value; and
a scan region determiner which determines the partitioned regions to be object or non-object regions based on a result of the comparison and outputs the second scan control signal.

15. The apparatus according to claim 14, wherein the region partitioner partitions the first scan image into horizontal/vertical regions in units of a predetermined pixel or size.

16. A method of scanning an object placed between an original cover and a glass plane of a scanning apparatus, comprising:
scanning the object and processing image signals if the original cover is fully closed; performing a first scan on the object and storing the first scan image if the original cover is not fully closed;
partitioning the stored first scan image into a predetermined size of regions and calculating an average brightness of the partitioned regions;
classifying regions having average brightness differences greater than the reference value to be object regions and regions having average brightness differences less than the reference value to be non-object regions; and
processing the non-object regions as white level regions during a second scan.

17. The method according to claim 16, wherein in the partitioning of the first scan image operation, the first scan image is partitioned into horizontal/vertical regions in units of a predetermined pixel or size.

18. The method according to claim 16, wherein the partitioning of the first scan image comprises:
partitioning the first scan image into regions and calculating an average brightness of the regions;
comparing the average brightness of the regions and the average brightness of adjacent regions; and
comparing the average brightness difference with the reference value.

19. The method according to claim 16, wherein in the classifying of the regions operation, regions having average gray level differences less than the reference value as a result of the comparison are determined to be the non-object regions and are processed as white level regions during the second scan.

20. The method according to claim 16, wherein in the classifying of the regions operation, regions having average brightness differences greater than the reference value as a result of the comparison are determined to be the object regions and are processed as image data regions during the second scan.
